(19) United States
(12) Patent Application Publication
(10) Pub. No.: US 2014/0091220 A1
(43) Pub. Date: Apr. 3, 2014

(54) MICROBOLOMETER ARCHITECTURE

(71) Applicant: TELEDYNE DALSA INC., Waterloo (CA)

(72) Inventor: Binqiao Li, Waterloo (CA)

(73) Assignee: TELEDYNE DALSA INC., Waterloo (CA)

(21) Appl. No.: 13/632,259

(22) Filed: Oct. 1, 2012

(51) Int. Cl. G01J 5/10

(52) U.S. Cl. 250/340; 250/349

(57) ABSTRACT

An infrared imaging device that groups two or more active radiation detectors with at least one shielded radiation detector for cancelling the self-heating effect from the active radiation detectors is disclosed. A power supply is coupled to the group containing active and at least one shielded radiation detector to provide power to the group synchronously so that the active and shielded radiation detectors will be subjected to the same self-heating effect. A readout module subtracts a reference signal received from the shielded radiation detectors from each of the active signals received from each of the active radiation detectors. The infrared imaging device can have one or more shielded radiation detectors for each row of active radiation detectors in an infrared imaging array.

### FIELD

The present disclosure relates generally to microbolometer infrared/thermal detectors. More particularly, the disclosure relates to compensating for the self-heating effect in microbolometers.

### BACKGROUND

Microbolometer thermal detectors based on silicon read out circuit are used for the detection of infrared radiation (IR) and are typically used in thermal cameras. Recent advances in micromachining technology have made it possible to fabricate highly sensitive thermal IR detectors. In contrast to conventional photon-based thermal detectors, microbolometers can be operated at room temperature and do not require an expensive or bulky cooling apparatus. Un-cooled microbolometer thermal detectors can be monolithically integrated with readout electronics to create large and inexpensive thermal detector arrays. Microbolometers are relatively easier to fabricate and have a relatively decent response compared to other thermal detector technology.

A microbolometer measures the power of incident electromagnetic radiation via the heating of a material with a temperature-dependent electrical resistance. In order to read the resistance of the microbolometer, current is passed through the device during readout which also causes a self-heating effect that limits the sensitivity of the microbolometer. This self-heating artifact is often referred to as a DC pedestal in the output signal and the signal of interest represents a very small voltage above this DC pedestal.

This self heating phenomena is not common for other types of IR detectors. For example, the detector structure mentioned in U.S. Pat. No. 6,583,416 does not have a self heating issue because an infrared sensitive capacitor is used to temperature. There is no self-heating effect because there is no DC current applied to the pixel. The patent uses blind reference pixel that is shielded from the incident thermal/IR radiation to cancel out a thermal effect related to the temperature of the detector and fixed pattern signal noise. This type of thermal effect is a different concept from the self heating effect of microbolometers. Self heating is a per element heat due to current flow which is different from the overall detector temperature that is addressed by the '416 patent. To cancel out the detector temperature effect it does not matter how the blind pixels are positioned as is illustrated by the variety of configurations shown in the patent.

The '416 patent also presents a detector structure in which the active pixel signals are read out one-by-one by addressing each pixel. Each pixel signal is read out with a blind reference pixel signal to cancel the thermal effect. Because the number of active pixel is much larger than the blind pixels each blind pixel will be read multiple times in one frame read out period. This operation is ineffective to cancel self-heating because reading the blind pixel multiple times per active pixel will result in a different amount of self-heating between the active and blind pixels.

Attempts to alleviate the self-heating effect include applying a voltage pulse to the microbolometer rather than a steady voltage. The voltage pulse has a shorter time period than the thermal time constant of the microbolometer but the effects of self-heating are still present. Other attempts, such as that described in European Patent No. 798545, describe using an active microbolometer for detecting infrared radiation, a blind microbolometer to compensate for the self heating effect and a differential amplifier detection circuit. The blind microbolometer is shielded from infrared radiation so that any change in resistance of the blind microbolometer is not due to incident radiation but includes the self-heating effect. These blind microbolometers may also be referred to as IR blind. European Patent No. 798545 further describes using a Wheatstone bridge configuration to cancel out the self-heating effect between the active and blind microbolometer.

The problem with the approach described by European Patent No. 798545 is that every active microbolometer must have a corresponding blind microbolometer and both must be read simultaneously to cancel the self-heating effect. This requires a larger physical layout and provides a lower fill factor to accommodate the blind resistors (i.e. the layout area of the blind resistor limits the number of active microbolometers per unit of area). The active and blind pixels must be readout (i.e. activated by the same voltage signal) at the same time to produce the same self-heating effect in order to cancel this effect out between the active and blind resistor.

### SUMMARY

Accordingly, there is provided an infrared imaging device having a shielded radiation detector that is powered synchronously with multiple active radiation detectors to correct for the self-heating effect and improve upon some of the issues noted above.

In a first aspect, an infrared imaging device is provided comprised of two or more active radiation detectors, the active radiation detectors change in resistance in response to incident infrared radiation; a shielded radiation detector that is shielded from incident infrared radiation, the shielded radiation detector corresponding to the two or more active radiation detectors; and a power supply coupled to the two or more active radiation detectors and the shielded radiation detector, the power supply configured to simultaneously provide power during a readout period to the two or more active radiation detectors and the shielded radiation detector wherein self-heating affecting change in resistance caused by current from the power supply is correlated between the two or more active radiation detectors and the shielded radiation detector. In some aspects, the infrared imaging device can further comprise a readout module coupled to a corresponding one of the two or more active radiation detectors and the shielded radiation detector. In still further aspects, the readout module is configured to subtracts a reference signal received from the shielded radiation detector from an active signal received from each of the two or more active radiation detectors.

In a second aspect, a method for reading an infrared imaging device is provided, the infrared imaging device having a plurality of groups of active radiation detectors that are subject to a self-heating effect, each of the groups having at least one corresponding shielded radiation detector. The method comprises selecting a group from the plurality of groups and the at least one corresponding shielded radiation detector; applying power synchronously to the selected group and the at least one corresponding shielded radiation detector; and subtracting a reference signal received from the at least one corresponding shielded radiation detector from active signals received from each of the active radiation detectors of the selected group, wherein removing the reference signal cancels the self-heating effect for each of the active radiation detectors.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of an infrared image device;

FIG. 2 is a block diagram of alternative embodiment of an infrared imaging device illustrating an embodiment of a readout module; and

FIG. 3 is a flow chart diagram of a method for reading an infrared imaging device having a group of active radiation detectors subject to a self-heating effect, the group having a corresponding shielded radiation detector.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather provides exemplary embodiments that could be varied or modified by a person skilled in the art.

The terms “row” and “column” are used herein to refer to the manner of addressing infrared radiation detectors in a two-dimensional array. The terms “row” and “column” are not meant to be limiting in a geometrical manner with the exception that rows are understood to be perpendicular to columns. For example, both rows and columns can be either vertical or horizontal as the terms are used herein.

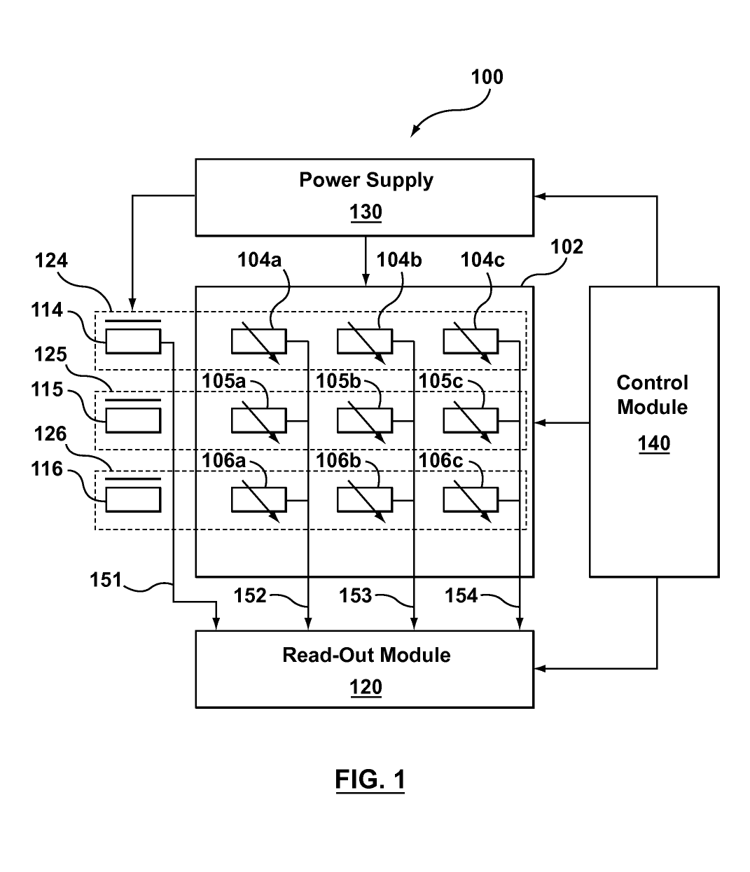

Referring first to FIG. 1, a block diagram of an infrared image device 100 is shown. Infrared imaging device 100 comprises an infrared imaging array 102 that includes an array of active radiation detectors 104-106. Infrared radiation strikes active radiation detectors 104-106, heating it, and thus changing its electrical resistance. This resistance change is measured and processed into a current or voltage by readout module 120. The a current or voltage outputs from readout module 120 can be used to create a thermal image. Readout module 120 can be implemented on the same substrate as infrared imaging array 102 and, in some embodiments, can also comprise a separate readout IC.

Active radiation detectors 104-106 are preferably implemented as microbolometers that contain a temperature sensitive resistor, and unlike other infrared detecting equipment do not require cooling. The term “active” is used to distinguish active radiation detectors 104-106 from shielded radiation detectors 114-116. Power supply 130 is coupled to infrared imaging array 102 and active radiation detectors 104-106. Power supply 130 provides the electrical current that is supplied to active radiation detectors 104-106 in order to measure change in resistance during readout. Operation of active radiation detectors 104-106 is significantly affected by generation of self-heating when current is passed through active radiation detectors 104-106 during readout.

Shielded radiation detectors 114-116 are provided to cancel out the self-heating effect. Shielded radiation detectors 114-116 are constructed similarly to active radiation detectors 104-106 but further include a radiation shielding element, such as a radiation shielding film, to prevent infrared radiation from effecting the resistance of shielded radiation detectors 114-116. Changes in resistance of shielded radiation detectors are thus not due to incident infrared radiation.

Each of shielded radiation detectors 114-116 corresponds to a group of two or more active radiation detectors 104-106. The shielded radiation detector and its corresponding group of active radiation detectors are coupled to the power supply during the readout period so that the shielded radiation detector and active radiation detectors receive the same current and are subject to the same self-heating effect. Readout module 120 is configured to subtract a reference signal from the shielded radiation detector from an active signal from each of the corresponding active radiation detectors in order to cancel out the self-heating effect in the active signal.

Shielded radiation detectors 114-116 can be provided within infrared imaging array 102 or positioned outside infrared imaging array 102. Preferred embodiments position shielded radiation detectors 114-116 outside or on the edges infrared imaging array 102 so that shielded radiation detectors do not affect the fill factor of infrared imaging array 102.

Grouping of active radiation detectors 104-106 with shielded radiation detectors can be based on positioning. FIG. 1 illustrates grouping of shielded radiation detectors 114-116 with corresponding active radiation detectors 104-106 by rows 124-126. Preferably, shielded radiation detectors 114-116 are grouped with active radiation detectors 114-116 based on proximity so that the shielded radiation detectors and active radiation detectors are subject to similar temperature effects from the substrate and can be routed/wired with the other grouped radiation detectors. Proximity will also ensure that the grouping shares similar routing from power supply 130 and thus suffer from similar power noise issues. An alternative embodiment could include shielded radiation detectors positioned on each end of the row with each shielded radiation detector being grouped with the active radiation detectors in the half of the row adjacent the shielded radiation detector.

Other embodiments can employ other grouping that are not limited by the device geometry. In still other embodiments, multiple shielded radiation detectors can be grouped with active radiation detectors. For example, shielded radiation detectors can be positioned at each end of rows 124-126 adjacent infrared imaging array 102. Readout module 120 can either average the reference signal from multiple shielded radiation detectors or select the reference signal from one of the multiple radiation detectors based on median value or other criteria.

Grouping by rows 124-126 allows for readout module 120 to read each row of active radiation detectors 104-106 with their corresponding shielded radiation detectors 114-116 in sequence using shared column buses 151-154. The active radiation detectors and the shielded radiation detector of the row are simultaneously biased by power supply 130 and sampled by readout module 120. The active radiation detectors and the shielded radiation detector receive power synchronously during the readout period so that the self-heating affecting a change in resistance due to current from the power supply is correlated between the active radiation detectors and the shielded radiation detector. This allows the signal from the shielded radiation detector to be used as a reference signal to remove the self-heating effect from the active radiation detectors that are grouped and similarly powered with the shielded radiation detector. This architecture also provide strong power noise cancellation because power noise from power supply 130 coupled into active and shielded radiation detectors are correlated during readout.

Control module 140 provides control signals to power supply 130, infrared imaging array 102, and readout module 120 to synchronize reading shielded radiation detectors with their corresponding group of active radiation detectors. Control module 140 can provide a row selection signal to activate a particular row 124-126 to couple power supply 130 to the radiation detectors and the radiation detectors to their corresponding column bus 151-154. Control module 140 can also provide control signals to power supply 130 to initiate a voltage pulse to generate a current pulse across active and shielded radiation detectors. Using a voltage pulse biases the radiation detectors for a shorter period of time to help reduce the self-heating effect.

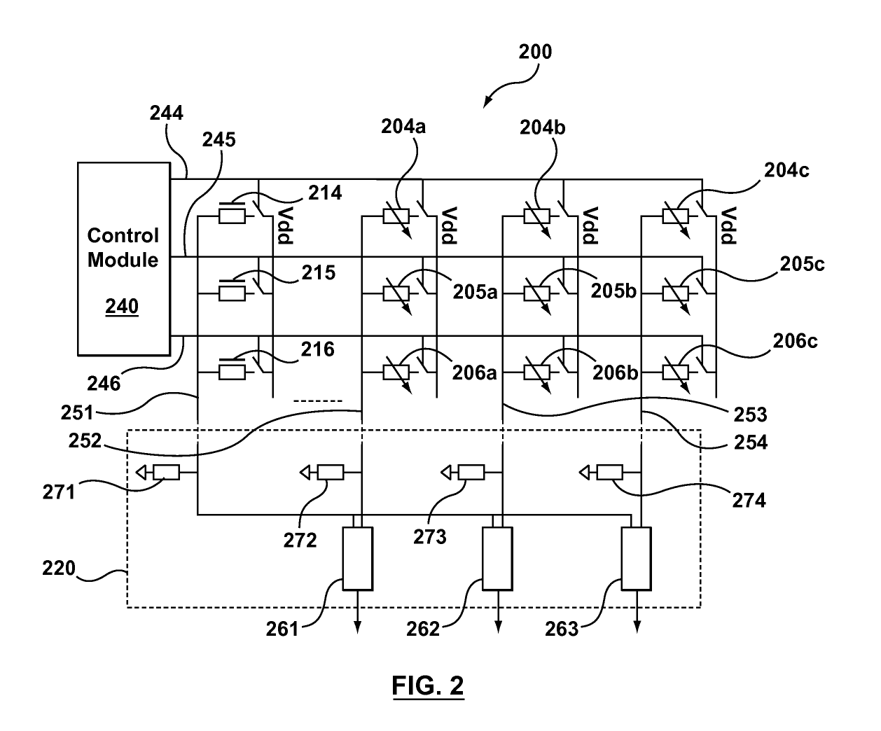

Referring now to FIG. 2, an alternative embodiment of an infrared imaging device 200 is shown illustrating an embodiment of readout module 220. Similar elements from FIG. 1 are similarly numbered in FIG. 2. Infrared imaging device 200 comprises an infrared imaging array, including an array of active radiation detectors 204-206 each aligned in rows, and shielded radiation detectors 214-216.

Infrared imaging device 200 further comprises control module 240 that provides row selection signals 244-246 to a power switch for each row. The power switch is implemented as a row selection switch for each of the active and shielded radiation detectors that couples the radiation detector to the power supply lines (labelled as Vdd). Control module 240 asserts row selection signals 244-246 sequentially to allow readout module 220 to read each row in parallel in sequence. For example, asserting row selection signal 244 couples shielded radiation detector 214 and active radiation detectors 204a-c to the power supply signal, Vdd. Readout module 220 can then sample the row activated by row selection signal 244 (i.e. shielded radiation detector 214 and active radiation detectors 204a-c) from column buses 251-254.

Readout module 220 comprises differential readout circuits 261-263 that are coupled to active radiation detectors via column buses 252-254. The reference signal from shielded radiation detectors 214-216 is shared between differential readout circuits 261-263 via column bus 251. Readout circuits 261-263 removes the reference signal provided by shielded radiation detectors 214-216 from the output sampled from active radiation detectors 204-206. Readout circuits 261-263 can be implemented using a differential amplifier configuration or a capacitive transimpedance amplifier. Input to differential readout circuits 261-263 can also be sampled from an impedance bridge configuration. FIG. 1 illustrates a Wheatstone bridge as an example that includes thermally shorted resistor 271 and one of the shielded radiation detectors 214-216 forming one leg of the bridge and the other leg of the bridge formed by one of thermally shorted resistors 272-274 with the corresponding one of active radiation detectors 204-206. Thermally shorted resistors 271-274 can be thermally shorted to the substrate and there is no self heating effect when current is applied to it.

Readout module 220 can further include an analog-to-digital (ADC) converter circuit and a digital memory that serves as the image buffer. Embodiments can include either the ADC or the ADC and memory on chip with the infrared radiation detectors or in a separate readout integrated circuit.

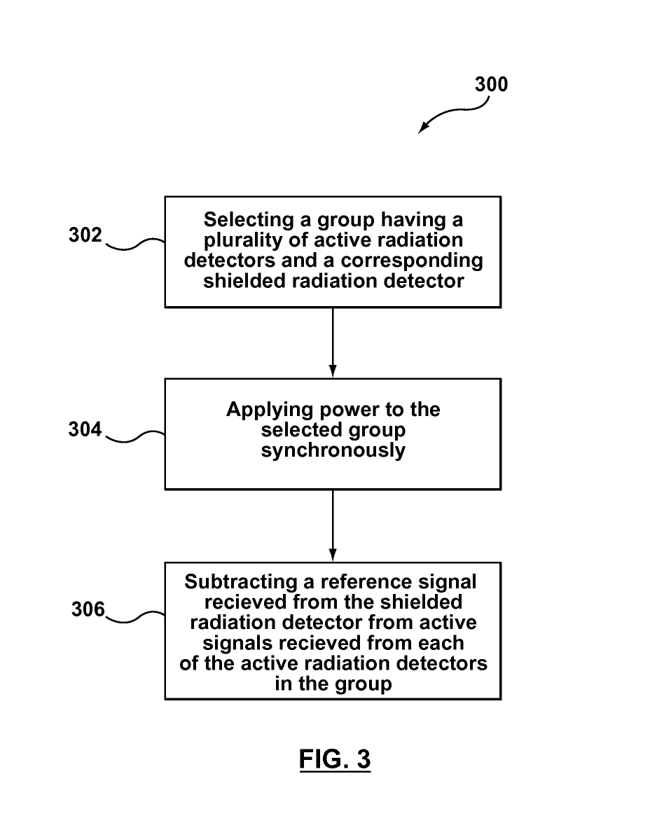

Referring now to FIG. 3, a method 300 for reading an infrared imaging device having rows 124-126 of active radiation detectors 104-106 each row having a corresponding shielded radiation detector 114-116. Method 300 is directed to sharing the output of one or more shielded radiation detectors 114 among multiple active radiation detectors 104a-c to cancel out the self-heating effect in active radiation detectors 104a-c. Method 300 begins at step 302 with selecting a row 124-126 of active radiation detectors 104-106 from the infrared imaging array 102 and one or more shielded radiation detectors 114-116 that correspond to the row. Next, at step 304, power from power supply 130 is applied synchronously to active radiation detectors 104a-c in the selected row 124 and one or more shielded radiation detectors 114.

During the application of power a reference signal is sampled from the one or more shielded radiation detectors that is subtracted from each of the active signals sampled from each of the active radiation detectors in the selected row at step 306. Steps 302, 304 and 306 can be repeated for each row in the infrared imaging device. Where more than one shielded radiation detector is used, the reference signal can be an average or median of the output from the multiple shielded radiation detectors. Readout module 120 can include additional logic to process the sampled signals from each shielded radiation detector to provide the reference signal.

In step 304 power can be applied by provide row selection signal 244-246 that couples active radiation detectors 204-206 and shielded radiation detectors 214-216 to power supply 130. The power can be supplied as a voltage pulse that biases both shielded and active radiation detectors at the same time and for the same time period.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. An infrared imaging device comprising:
two or more active radiation detectors, the active radiation detectors change in resistance in response to incident infrared radiation;
a shielded radiation detector that is shielded from incident infrared radiation, the shielded radiation detector corresponding to the two or more active radiation detectors; and
a power supply coupled to the two or more active radiation detectors and the shielded radiation detector, the power supply configured to simultaneously provide power during a readout period to the two or more active radiation detectors and the shielded radiation detector wherein self-heating affecting change in resistance caused by current from the power supply is correlated between the two or more active radiation detectors and the shielded radiation detector.

2. The infrared imaging device of claim 1 further comprising:
a readout module coupled to a corresponding one of the two or more active radiation detectors and the shielded radiation detector.

3. The infrared imaging device of claim 2, wherein the readout module is configured to subtracts a reference signal received from the shielded radiation detector from an active signal received from each of the two or more active radiation detectors.

4. The infrared imaging device of claim 3 wherein the readout module comprises any one of a differential amplifier and a capacitive transimpedance amplifier.

5. The infrared imaging device of claim 4 wherein the readout module further comprises an impedance bridge having thermally shorted resistors.

6. The infrared imaging device of claim 3 further comprising a plurality of rows each having two or more active radiation detectors, each of the plurality of rows having a corresponding shielded radiation detector, each of the two or more active radiation detectors and the corresponding shielded radiation detector of one of the rows of the plurality of rows coupled to the readout module via a corresponding column bus.

7. The infrared imaging device of claim 6 wherein each of the plurality of rows has at least two shielded radiation detectors and wherein the reference signal is any one of an averaged signal and a median signal from the at least two shielded radiation detectors.

8. The infrared imaging device of claim 7 wherein the shielded radiation detectors are positioned at both ends of the row of the corresponding active radiation detectors.

9. The infrared imaging device of claim 6 wherein the power supply is coupled to the two or more active radiation detectors and the shielded radiation detector by a power switch.

10. The infrared imaging device of claim 9 wherein the power switch comprises two or more row selection switches, each row selection switch corresponding to one of the active radiation detectors and the shielded radiation detectors.

11. The infrared imaging device of claim 10 further comprising a control module that provides a plurality of row selection signals, each of the row selection signals coupled to the row selection switches in one of the plurality of rows to readout each radiation detector in the corresponding row in parallel.

12. The infrared imaging device of claim 1 wherein the active and shielded radiation detectors are microbolometers.

13. The infrared imaging device of claim 1 wherein the shielded radiation detectors are in proximity to the active radiation detectors.

14. The infrared imaging device of claim 1 wherein the power supply provides a voltage pulse.

15. A method for reading an infrared imaging device having a plurality of groups of active radiation detectors that are subject to a self-heating effect, each of the groups having at least one corresponding shielded radiation detector, the method comprising:
selecting a group from the plurality of groups and the at least one corresponding shielded radiation detector;
applying power synchronously to the selected group and the at least one corresponding shielded radiation detector; and
subtracting a reference signal received from the at least one corresponding shielded radiation detector from active signals received from each of the active radiation detectors of the selected group, wherein removing the reference signal cancels the self-heating effect for each of the active radiation detectors.

16. The method of claim 15 further comprising repeating selecting a group, applying power and removing the reference signal for each of the plurality of groups of active radiation detectors.

17. The method of claim 16 wherein the plurality of groups are rows of the infrared imaging device.

18. The method of claim 17 wherein applying power comprises providing a row selection signal to couple the row to a power supply.

19. The method of claim 17 wherein each row includes two or more shielded radiation detectors and the reference signal is any one of an average, median or selected signal from each of the two or more shielded radiation detectors.

20. The method of claim 18 wherein the power supply provides a voltage pulse.
